(19) United States
(12) Patent Application Publication
(10) Pub. No.: US 2011/0286084 A1
(43) Pub. Date: Nov. 24, 2011

(54) RAMAN AMPLIFIER

(76) Inventor: TAKAHIRO TOMITA, Tokyo (JP)

(21) Appl. No.: 13/103,904

(22) Filed: May 9, 2011

(30) Foreign Application Priority Data
May 19, 2010 (JP) P2010-115191

(51) Int. Cl. H01S 3/30

(52) U.S. Cl. 359/334

(57) ABSTRACT

A Raman amplifier includes a semiconductor laser and an optical amplification fiber connected to an optical transmission fiber used for transmitting optical signals. In the Raman amplifier, excitation light emitted from the semiconductor laser is introduced into the optical amplification fiber while excitation light is incident on the optical transmission fiber, thus amplifying optical signals owing to stimulated emission of Raman scattering in both the optical amplification fiber and the optical transmission fiber. The optical amplification fiber is connected to the upstream/downstream side of the optical transmission fiber along the transmitting direction of optical signals, so that excitation light is introduced into the optical amplification fiber inversely toward the downstream/upstream side of the optical transmission fiber along the transmitting direction. The Raman amplifier including a single semiconductor laser can be reduced in manufacturing cost.

This application claims priority on Japanese Patent Application No. 2010-115191, the content of which is incorporated herein by reference.

### BACKGROUND OF THE INVENTION

1. Field of the Invention

This invention relates to Raman amplifiers that amplify excitation light incident on optical fibers transmitting optical signals.

2. Description of the Related Art

Conventionally, optical communication systems have been developed and used to transmit optical signals through optical fibers. One type of optical communication system is designed to introduce excitation light into optical fibers and to amplify optical signals owing to stimulated emission of Raman scattering, wherein light whose wavelength differs from that of excitation light is scattered owing to interaction between excitation light and molecular vibration occurring in optical fibers. Owing to stimulated emission of Raman scattering, optical signals are amplified in a certain wavelength range longer than the wavelength of excitation light.

By using optical fibers composed of quartz glass, for example, it is possible to amplify optical signals in a desired wavelength range which is approximately 100 nm (or 13 THz) longer than the wavelength of excitation light. By appropriately selecting the wavelength of excitation light, it is possible to amplify optical signals in an arbitrary wavelength range.

This type of optical communication system adopts Raman amplifiers, one example of which is disclosed in Patent Document 1. The Raman amplifier disclosed in Patent Document 1 is constituted of an optical amplification buffer connected to an optical transmission fiber, a first semiconductor laser (e.g. a laser diode) emitting excitation light, and a second semiconductor laser emitting excitation light.
Patent Document 1: Japanese Patent Application Publication No. 2006-74344

The Raman amplifier is designed such that excitation light of the first semiconductor laser is incident on the optical transmission fiber whilst excitation light of the second semiconductor laser is incident on the optical amplification fiber. Thus, it is possible to adequately increase power of optical signals (or to adequately amplify optical signals) without using excessive power of excitation light incident on the optical transmission fiber.

This Raman amplifier needs two semiconductor lasers (i.e. first and second semiconductor lasers) incorporated therein; hence, it is highly costly to manufacture.

### SUMMARY OF THE INVENTION

It is an exemplary object of this invention to provide a Raman amplifier having a simple configuration, which is not highly costly to manufacture.

A Raman amplifier of this invention includes an optical amplification fiber connected to an optical transmission fiber for transmitting optical signals, and a semiconductor laser that emits excitation light. Herein, excitation light of the semiconductor laser is introduced into both the optical amplification fiber and the optical transmission fiber, thus amplifying optical signals owing to stimulated emission of Raman scattering in both the optical amplification fiber and the optical transmission fiber.

A Raman amplification system of this invention includes an optical transmission fiber that transmits optical signals, a first Raman amplifier, and a second Raman amplifier.

The first Raman amplifier includes a first semiconductor laser that emits excitation light and a first optical amplification fiber connected to the optical transmission fiber in a downstream side along a transmitting direction of optical signals. Herein, excitation light of the first semiconductor laser is introduced into the first optical amplification fiber toward an upstream side along the transmitting direction while the excitation light is incident on the optical transmission fiber, thus amplifying optical signals owing to stimulated emission of Raman scattering in both the first optical amplification fiber and the optical transmission fiber.

The second Raman amplifier includes a second semiconductor laser that emits excitation light and a second optical amplification fiber connected to the optical transmission fiber in the upstream side along the transmitting direction of optical signals. Herein, the excitation light of the second semiconductor laser is introduced into the second optical amplification fiber toward the downstream side along the transmitting direction while the excitation light is incident on the optical transmission fiber, thus amplifying optical signals owing to stimulated emission of Raman scattering in both the second optical amplification fiber and the optical transmission fiber.

In addition, this invention refers to a Raman amplification method for a Raman amplifier including a semiconductor laser and an optical amplification fiber connected to an optical transmission fiber, wherein excitation light of the semiconductor laser is introduced into the optical amplification fiber and the optical transmission fiber, thus amplifying optical signals owing to stimulated emission of Raman scattering in both the optical amplification fiber and the optical transmission fiber.

Furthermore, this invention refers to a Raman amplification method for a Raman amplification system including an optical transmission fiber, a first Raman amplifier, and a second Raman amplifier, wherein the first Raman amplifier includes a first semiconductor laser and a first optical amplification fiber connected to the optical transmission fiber in the downstream side along the transmitting direction of optical signals, whilst the second Raman amplifier includes a second semiconductor laser and a second optical amplification fiber connected to the optical transmission fiber in the upstream side along the transmitting direction of optical signals. In the first Raman amplifier, excitation light of the first semiconductor laser is introduced into the first optical amplification fiber toward the upstream side along the transmitting direction while the excitation light is incident on the optical transmission fiber, thus amplifying optical signals owing to stimulated emission of Raman scattering in both the first optical amplification fiber and the optical transmission fiber. In the second Raman amplifier, excitation light of the second semiconductor laser is introduced into the second optical amplification fiber toward the downstream side along the transmitting direction while the excitation light is incident on the optical transmission fiber, thus amplifying optical signals owing to stimulated emission of Raman scattering in both the second optical amplification fiber and the optical transmission fiber.

Since the Raman amplifier of this invention has a simple constitution including a single semiconductor laser and an optical amplification fiber, it is possible to reduce the manufacturing cost thereof.

### BRIEF DESCRIPTION OF THE DRAWINGS

These and other objects, aspects, and exemplary embodiments will be described in more detail with reference to the following drawings.

FIG. 1 is a circuit diagram of a Raman amplifier according to a first exemplary embodiment.

FIG. 2 is a circuit diagram of a Raman amplifier according to a second exemplary embodiment.

FIG. 3 is a circuit diagram of a Raman amplification system according to a third exemplary embodiment.

FIG. 4 is a circuit diagram of a Raman amplifier according to a fourth exemplary embodiment.

### DESCRIPTION OF THE PREFERRED EMBODIMENTS

This invention will be described in further detail by way of examples with reference to the accompanying drawings.

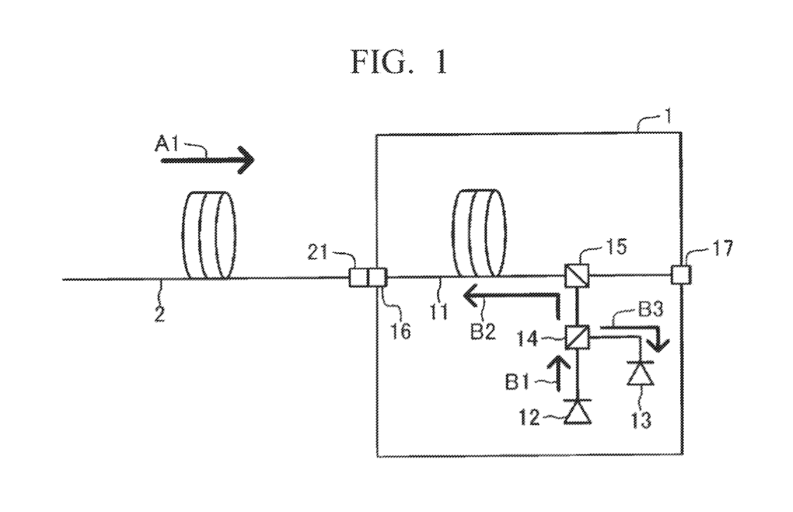

This invention refers to various examples of Raman amplifiers shown in FIGS. 1 to 4, in which corresponding parts are designated by the same reference numerals; hence, detailed descriptions thereof will be simplified.

### 1. First Exemplary Embodiment

FIG. 1 shows a Raman amplifier 1 according to a first exemplary embodiment. The Raman amplifier 1 amplifies optical signals owing to stimulated emission of Raman scattering. The Raman amplifier 1 is connected to an optical transmission fiber 2 used for transmitting optical signals.

Optical signals may have a single frequency range selected from among an O band, an E band, an S band, a C band and an L band, for example. Alternatively, optical signals may have a composite frequency band composed of plural bands.

The Raman amplifier 1 of the first exemplary embodiment is installed in an optical repeater which relays (or transfers) optical signals being transmitted through the optical transmission fiber 2. Alternatively, the Raman amplifier 1 can be installed in an optical receiver used for receiving optical signals transmitted from the optical transmission fiber 2.

The Raman amplifier 1 is constituted of an optical amplification fiber 11, a semiconductor laser 12, an optical reception element 13, an optical branch coupler 14, a WDM (Wavelength Division Multiplexing) coupler 15, and an optical input port 16.

The optical amplification fiber 11 is connected to the optical transmission fiber 2 in a downstream side along a transmission direction A1 in which optical signals are transmitted through the optical transmission fiber 2. Specifically, the optical amplification fiber 11 is connected to the optical transmission fiber 2 such that the optical input port 16 (which is disposed at a distal end of the optical amplification fiber 11) is coupled with a connector 21 (which is disposed at a distal end of the optical transmission fiber 2).

In this constitution, optical signals transmitted through the optical transmission fiber 2 are output from an optical output port 17 which is disposed at an opposite end of the optical amplification fiber 11 having the optical input port 16.

As long as excitation light (which is emitted from the semiconductor laser 12) is incident on the optical amplification fiber 11, the optical amplification fiber 11 is able to amplify optical signals at a higher amplification factor than a single mode fiber (SMF).

In the first exemplary embodiment, the optical amplification fiber 11 serves as an optical dispersion compensating fiber (DCF). Alternatively, the optical amplification fiber 11 may serve as other types of fibers such as TW-RS (a registered trademark for “True Wave Reduced Slope Fiber”), E-LEAF (Enhanced Large Effective Area Fiber), and DSF (Dispersion Shifted Fiber).

The semiconductor laser 12 emits a laser beam as excitation light owing to recombination radiation of a semiconductor. The semiconductor laser 12 is referred to as a laser diode or a diode laser. The optical reception element 13 serves as a photo detector, which receives excitation light emitted from the semiconductor laser 12 so as to detect power of excitation light.

Based on the power of excitation light detected by the optical reception element 13, the Raman amplifier 1 controls electric power supplied to the semiconductor laser 12, thus controlling the power of excitation light emitted from the semiconductor laser 12.

The optical branch coupler 14 branches out excitation light emitted from the semiconductor laser 12. Thus, the excitation light emitted from the semiconductor laser 12 is incident on the optical reception element 13 in a direction B3 and the WDM coupler 15 in a direction B2.

The WDM coupler 15 is attached to the optical amplification fiber 11. The WDM coupler 15 transmits the excitation light into the optical amplification fiber 11 in an upstream direction, i.e. the direction B2, which is inverse to the direction A1 for transmitting optical signals through the optical transmission fiber 2.

As long as the excitation light is incident on the optical amplification fiber 11, the optical amplification fiber 11 amplifies optical signals owing to stimulated emission of Raman scattering. In addition, the optical amplification fiber 11 transmits the excitation light into the optical transmission fiber 2, so that the excitation light is incident on the optical transmission fiber 2.

As long as the excitation light is incident on the optical transmission fiber 2, the optical transmission fiber 2 amplifies optical signals owing to stimulated emission of Raman scattering.

In this constitution, stimulated emission of Raman scattering occurs in both of the optical amplification fiber 11 and the optical transmission fiber 2. This makes it possible to amplify optical signals in both of the optical amplification fiber 11 and the optical transmission fiber 2.

As described above, the Raman amplifier 1 of the first exemplary embodiment is able to adequately increase (or amplify) the power of optical signals without using an excessively high power of excitation light incident on the optical transmission fiber 2. In short, the Raman amplifier 1 is able to adequately amplify reception power of optical signals.

The Raman amplifier 1 is characterized by using a single semiconductor laser 12. Compared to the conventional Raman amplifier using two semiconductor lasers, it is possible to reduce the manufacturing cost of the Raman amplifier 1.

Since a high intensity of excitation light highly affecting gain-wavelength characteristics is fixedly applied to a certain portion of an optical fiber, it is possible to considerably reduce variations of gain-wavelength characteristics.

### 2. Second Exemplary Embodiment

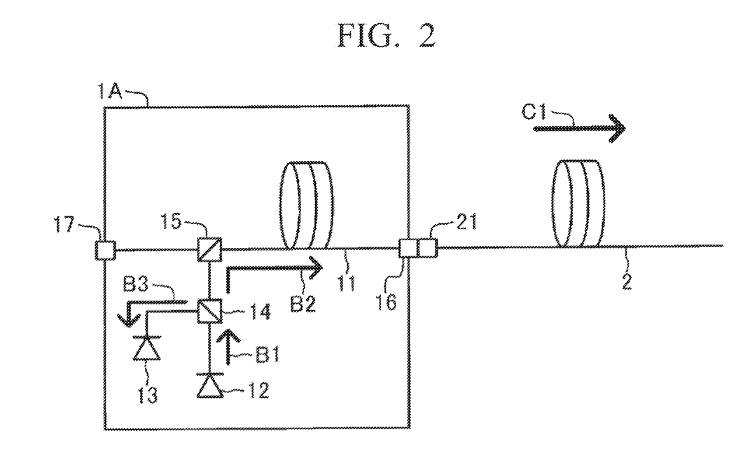

FIG. 2 shows a Raman amplifier 1A according to a second exemplary embodiment. The second exemplary embodiment differs from the first exemplary embodiment in that the Raman amplifier 1A is connected to the optical transmission fiber 2 in the upstream side for transmitting optical signals. The following description specifically refers to the distinction of the second exemplary embodiment compared to the first exemplary embodiment.

Basically, the Raman amplifier 1A of FIG. 2 has the same constitution as the Raman amplifier 1 of FIG. 1.

In the second exemplary embodiment, the Raman amplifier 1A is installed in an optical repeater which receives optical signals and outputs them into the optical transmission fiber 2. Alternatively, the Raman amplifier 1A can be installed in an optical transmitter which generates optical signals and outputs them into the optical transmission fiber 2.

The optical amplification fiber 11 is connected to the optical transmission fiber 2 in an upstream side along a direction C1 for transmitting optical signals through the optical transmission fiber 2. Specifically, the optical amplification fiber 11 is connected to the optical transmission fiber 2 such that the optical input coupler 16 (disposed at the distal end of the optical amplification fiber 11) is coupled with the connector 21 (disposed at the distal end of the optical transmission fiber 2).

In this constitution, optical signals input to the Raman amplifier 1A via the optical output port 17 (which is disposed at an opposite end of the optical amplification fiber 11 having the optical input port 16) are output into the optical transmission fiber 2 via the optical input port 16.

The WDM coupler 15 is attached to the optical amplification fiber 11. The WDM coupler 15 introduces excitation light into the optical amplification fiber 11 in a direction B2, i.e. a downward side of the direction C1 for transmitting optical signals through the optical transmission fiber 2.

As long as excitation light is incident on the optical amplification fiber 11, the optical amplification fiber 11 amplifies optical signals owing to stimulated emission of Raman scattering. In addition, the optical amplification fiber 11 transmits excitation light into the optical transmission fiber 2, so that the excitation light is incident on the optical transmission fiber 2.

As long as excitation light is incident on the optical transmission fiber 2, the optical transmission fiber 2 amplifies optical signals owing to stimulated emission of Raman scattering.

In this connection, stimulated emission of Raman scattering occurs in both of the optical amplification fiber 11 and the optical transmission fiber 2. This makes it possible to amplify optical signals in both of the optical amplification fiber 11 and the optical transmission fiber 2.

As described above, the Raman amplifier 1A of the second exemplary embodiment is able to adequately increase (or amplify) the power of optical signals without using an excessively high power of excitation light incident on the optical transmission fiber 2. In short, the Raman amplifier 1A is able to adequately amplify the transmission power of optical signals.

The Raman amplifier 1A is characterized by using a single semiconductor laser 12. Compared to the conventional Raman amplifier including two semiconductor lasers, it is possible to reduce the manufacturing cost of the Raman amplifier 1A.

### 3. Third Exemplary Embodiment

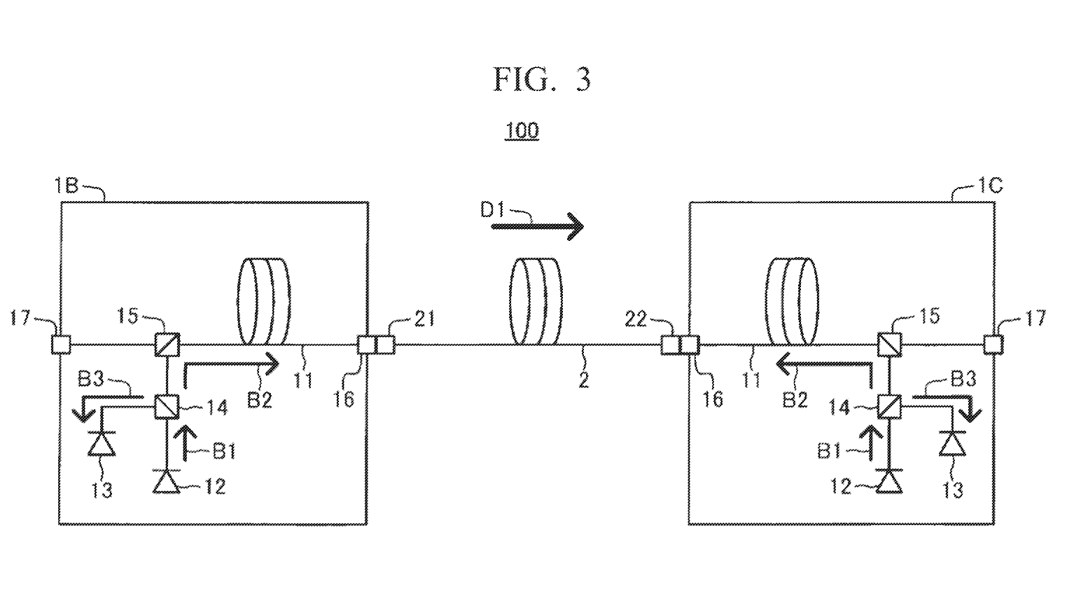

FIG. 3 shows a Raman amplification system 100 according to a third exemplary embodiment. The Raman amplification system 100 includes a first Raman amplifier 1B (whose constitution is equivalent to the constitution of the Raman amplifier 1A of the second exemplary embodiment) and a second Raman amplifier 1C (whose constitution is equivalent to the constitution of the Raman amplifier 1 of the first exemplary embodiment) as well as the optical transmission fiber 2.

The connector 21 is arranged at the distal end of the optical transmission fiber 2 in an upstream side along a direction D for transmitting optical signals through the optical transmission fiber 2. The connector 21 is connected to the optical input port 16 of the first Raman amplifier 1B.

Another connector 22 is arranged at the distal end of the optical transmission fiber 2 in a downstream side along the direction D1. The connector 22 is connected to the optical input port 16 of the second Raman amplifier 1C.

In this constitution of the Raman amplification system 100, stimulated emission of Raman scattering occurs in all the optical amplification fiber 11 of the first Raman amplifier 1B, the optical amplification fiber 11 of the second Raman amplifier 1C, and the optical transmission fiber 2. This makes it possible to amplify optical signals in all the optical amplification fiber 11 of the first Raman amplifier 1B, the optical amplification fiber 11 of the second Raman amplifier 1C, and the optical transmission fiber 2.

As described above, the Raman amplification system 100 of the third exemplary embodiment is able to adequately increase (or amplify) the power of optical signals without using an excessively high power of excitation light incident on the optical transmission fiber 2. In short, it is possible to adequately amplify the power of optical signals which are received by the second Raman amplifier 1C.

The Raman amplification system 100 is characterized in that each of the Raman amplifiers 1B, 1C needs a single semiconductor laser 12. Compared to the conventional Raman amplifier including two semiconductor lasers, it is possible to reduce the manufacturing cost of the Raman amplifiers 1B, 1C.

### 4. Fourth Exemplary Embodiment

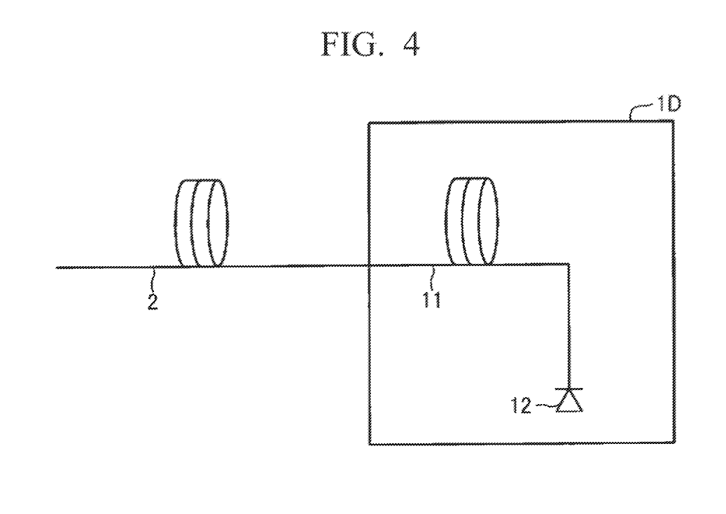

FIG. 4 shows a Raman amplifier 1D according to a fourth exemplary embodiment.

The Raman amplifier 1D of the fourth exemplary embodiment is connected to the optical transmission fiber 2 used for transmitting optical signals.

The Raman amplifier 1D includes the optical amplification fiber 11 connected to the optical transmission fiber 2, and the semiconductor laser 12 emitting excitation light.

Excitation light emitted from the semiconductor laser 12 is incident on both the optical amplification fiber 11 and the optical transmission fiber 2. This makes it possible to amplify optical signals owing to stimulated emission of Raman scattering in both the optical amplification fiber 11 and the optical transmission fiber 2.

In this constitution, stimulated emission of Raman scattering occurs in both the optical amplification fiber 11 and the optical transmission fiber 2. Thus, the Raman amplifier 1D is able to adequately increase (amplify) the power of optical signals without using an excessively high power of excitation light incident on the optical transmission fiber 2. The Raman amplifier 1D is characterized by using a single semiconductor laser 12. Compared to the conventional Raman amplifier including two semiconductor lasers, it is possible to reduce the manufacturing cost of the Raman amplifier 1D.

### 5. Variations

Although this invention has been described with reference to the foregoing exemplary embodiments, this invention is not necessarily limited to those exemplary embodiments, which can be further modified in various ways within the scope of the invention as defined in the appended claims.

This invention embraces any combination of the foregoing exemplary embodiments. For instance, it is possible to present the following features and variations, which are illustrative and not restrictive.

(1) A Raman amplifier includes an optical amplification fiber, which is connected to an optical transmission fiber used for transmitting optical signals, and a semiconductor laser for emitting excitation light. Excitation light emitted from the semiconductor laser is incident on both the optical amplification fiber and the optical transmission fiber. This makes it possible to amplify optical signals owing to stimulated emission of Raman scattering in both the optical amplification fiber and the optical transmission fiber.

In this constitution, stimulated emission of Raman scattering occurs in both the optical amplification fiber and the optical transmission fiber. Thus, the Raman amplifier is able to adequately increase (or amplify) the power of optical signals without using an excessively high power of excitation light incident on the optical transmission fiber. Compared to the conventional Raman amplifier including two semiconductor lasers, it is possible to reduce the manufacturing cost of the Raman amplifier including a single semiconductor laser.

(2) In the Raman amplifier, the optical amplification fiber can be connected to the optical transmission fiber in the downstream side along a transmitting direction of optical signals. Herein, excitation light of the semiconductor laser is introduced into the optical amplification fiber toward the upstream side in the transmitting direction. This constitution makes it possible to adequately amplify the power of optical signals received by the Raman amplifier.
(3) In the Raman amplifier, the optical amplification fiber can be connected to the optical transmission fiber in the upstream side along the transmitting direction. Herein, excitation light of the semiconductor laser is introduced into the optical amplification fiber toward the downstream side in the transmitting direction. This constitution makes it possible to adequately amplify the power of optical signals transmitted from the Raman amplifier.
(4) In the Raman amplifier according to at least one of the features (1) through (3), as long as excitation light is incident on the optical amplification fiber, the optical amplification fiber is able to amplify optical signals at a higher amplification factor than a single mode fiber (SMF).
(5) In the Raman amplifier according to at least one of the features (1) through (4), the optical amplification fiber may serve as one of TW-RS, E-LEAF, DSF and DCF.
(6) A Raman amplification system includes a first Raman amplifier and a second Raman amplifier. The first Raman amplifier includes a first semiconductor laser for emitting excitation light and a first optical amplification fiber connected to the optical transmission fiber in the downstream side along the transmitting direction of optical signals. Excitation light emitted from the first semiconductor laser is incident on the first optical amplification fiber toward the upstream side in the transmitting direction while excitation light is incident on the optical transmission fiber. Thus, the first Raman amplifier is able to amplify optical signals owing to stimulated emission of Raman scattering in both the first optical amplification fiber and the optical transmission fiber.

The second Raman amplifier includes a second semiconductor laser for emitting excitation light and a second optical amplification fiber connected to the optical transmission fiber in the upstream side along the transmitting direction. Excitation light emitted from the second semiconductor laser is incident on the second optical amplification fiber toward the downstream side in the transmitting direction while excitation light is incident on the optical transmission fiber. Thus, the second Raman amplifier is able to amplify optical signals owing to stimulated emission of Raman scattering in both the first optical amplification fiber and the optical transmission fiber.

(7) A Raman amplification method is adapted to a Raman amplifier including a semiconductor laser and an optical amplification fiber connected to an optical transmission fiber used for transmitting optical signals. Herein, excitation light emitted from the semiconductor laser is incident on both the optical amplification fiber and the optical transmission fiber. This makes it possible to amplify optical signals owing to stimulated emission of Raman scattering in both the optical amplification fiber and the optical transmission fiber.
(8) In the Raman amplification method according to the feature (7), the optical amplification fiber is connected to the optical transmission fiber in the downstream side along the transmitting direction of optical signals. Excitation light of the semiconductor laser is introduced into the optical amplification fiber toward the upstream side along the transmitting direction.
(9) In the Raman amplification method according to the feature (7), the optical amplification fiber is connected to the optical transmission fiber in the upstream side along the transmitting direction. Excitation light of the semiconductor laser is introduced into the optical amplification fiber toward the downstream side in the transmitting direction.
(10) A Raman amplification method is adapted to a Raman amplification system including an optical transmission fiber for transmitting optical signals in a transmitting direction, a first Raman amplifier, and a second Raman amplifier. The first Raman amplifier includes a first semiconductor laser and a first optical amplification fiber connected to the optical transmission fiber in the downstream side along the transmitting direction, whilst the second Raman amplifier includes a second semiconductor laser and a second optical amplification fiber connected to the optical transmission line in the upstream side along the transmitting direction. The Raman amplification method implements the following procedures.

Excitation light emitted from the first semiconductor laser is introduced into the first optical amplification fiber toward the upstream side along the transmitting direction while excitation light is incident on the optical transmission fiber. This makes it possible to amplify optical signals owing to stimulated emission of Raman scattering in both the first optical amplification fiber and the optical transmission fiber.

Excitation light emitted from the second semiconductor laser is introduced into the second optical amplification fiber toward the downstream side along the transmitting direction while excitation light is incident on the optical transmission fiber. This makes it possible to amplify optical signals owing to stimulated emission of Raman scattering in both the second optical amplification fiber and the optical transmission fiber.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the claims.

What is claimed is:

1. A Raman amplifier comprising:
an optical amplification fiber connected to an optical transmission fiber for transmitting optical signals; and
a semiconductor laser that emits excitation light,
wherein the excitation light emitted from the semiconductor laser is introduced into both the optical amplification fiber and the optical transmission fiber, thus amplifying optical signals owing to stimulated emission of Raman scattering in both the optical amplification fiber and the optical transmission fiber.

2. The Raman amplifier according to claim 1, wherein the optical amplification fiber is connected to the optical transmission fiber in a downstream side along a transmitting direction of optical signals, and wherein the excitation light of the semiconductor laser is introduced into the optical amplification fiber toward an upstream side along the transmitting direction.

3. The Raman amplifier according to claim 1, wherein the optical amplification fiber is connected to the optical transmission fiber in an upstream side along a transmitting direction of optical signals, and wherein the excitation light of the semiconductor laser is introduced into the optical amplification fiber toward a downstream side along the transmitting direction.

4. The Raman amplifier according to claim 1, wherein as long as the excitation light is incident on the optical amplification fiber, the optical amplification fiber amplifies optical signals at a higher amplification factor than a single mode fiber (SMF).

5. The Raman amplifier according to claim 1, wherein the optical amplification fiber serves as one of TW-RS, E-LEF, DSF, and DCF.

6. A Raman amplification system comprising:
an optical transmission fiber that transmits optical signals;
a first Raman amplifier; and
a second Raman amplifier,
wherein the first Raman amplifier includes a first semiconductor laser that emits excitation light and a first optical amplification fiber connected to the optical transmission fiber in a downstream side along a transmitting direction of optical signals, so that the excitation light of the first semiconductor laser is introduced into the first optical amplification fiber toward an upstream side along the transmitting direction while the excitation light is incident on the optical transmission fiber, thus amplifying optical signals owing to stimulated emission of Raman scattering in both the first optical amplification fiber and the optical transmission fiber, and
wherein the second Raman amplifier includes a second semiconductor laser that emits excitation light and a second optical amplification fiber connected to the optical transmission fiber in the upstream side along the transmitting direction of optical signals, so that the excitation light of the second semiconductor laser is introduced into the second optical amplification fiber toward the downstream side along the transmitting direction while the excitation light is incident on the optical transmission fiber, thus amplifying optical signals owing to stimulated emission of Raman scattering in both the second optical amplification fiber and the optical transmission fiber,

7. A Raman amplification method for a Raman amplifier including a semiconductor laser and an optical amplification fiber connected to an optical transmission fiber used for transmitting optical signals, comprising:
emitting excitation light with the semiconductor laser; and
introducing the excitation light into the optical amplification fiber and the optical transmission fiber, thus amplifying optical signals owing to stimulated emission of Raman scattering in both the optical amplification fiber and the optical transmission fiber.

8. The Raman amplification method for a Raman amplifier according to claim 7, wherein the optical amplification fiber is connected to the optical transmission fiber in a downstream side along a transmitting direction of optical signals, and wherein the excitation light of the semiconductor laser is introduced into the optical amplification fiber toward an upstream side along the transmitting direction.

9. The Raman amplification method for a Raman amplifier according to claim 7, wherein the optical amplification fiber is connected to the optical transmission fiber in an upstream side along a transmitting direction of optical signals, and wherein the excitation light of the semiconductor laser is introduced into the optical amplification fiber toward a downstream side along the transmitting direction.

10. A Raman amplification method for a Raman amplification system including an optical transmission fiber that transmits optical signals, a first Raman amplifier, and a second Raman amplifier, said first Raman amplifier including a first semiconductor laser and a first optical amplification fiber connected to the optical transmission fiber in a downstream side along a transmitting direction of optical signals, said second Raman amplifier including a second semiconductor laser and a second optical amplification fiber connected to the optical transmission fiber in an upstream side along the transmitting direction of optical signals,
said Raman amplification method comprising:
introducing excitation light emitted from the first semiconductor laser into the first optical amplification fiber toward the upstream side along the transmitting direction while the excitation light is incident on the optical transmission fiber, thus amplifying optical signals owing to stimulated emission of Raman scattering in both the first optical amplification fiber and the optical transmission fiber; and
introducing excitation light emitted from the second semiconductor laser into the second optical amplification fiber toward the downstream side along the transmitting direction while the excitation light is incident on the optical transmission fiber, thus amplifying optical signals owing to stimulated emission of Raman scattering in both the second optical amplification fiber and the optical transmission fiber.
